(19) United States
(12) Patent Application Publication
(10) Pub. No.: US 2023/0177053 A1
(43) Pub. Date: Jun. 8, 2023

(54) Query Optimizer Advisor

(71) Applicant: Microsoft Technology Licensing, LLC, Redmond, WA (US)

(72) Inventors: Matteo INTERLANDI, Torrance, CA (US); Wangda ZHANG, New York, NY (US); Paul S. MINEIRO, Bellevue, WA (US); Marc T. FRIEDMAN, Seattle, WA (US); Alekh JINDAL, Sammamish, WA (US); Hiren S. PATEL, Bothell, WA (US); Rafah Aboul HOSN, Chatham, NJ (US); Shi QIAO, Mercer Island, WA (US)

(21) Appl. No.: 17/705,978

(22) Filed: Mar. 28, 2022

Related U.S. Application Data
(60) Provisional application No. 63/286,676, filed on Dec. 7, 2021.

(51) Int. Cl. G06F 16/2453; G06F 11/34

(52) U.S. Cl. CPC G06F 16/24545; G06F 16/24549; G06F 11/3419

(57) ABSTRACT

Methods for optimization in query plans are performed by computing systems via a query optimizer advisor. A query optimizer advisor (QO-Advisor) is configured to steer a query plan optimizer towards more efficient plan choices by providing rule hints to improve navigation of the search space for each query in formulation of its query plan. The QO-Advisor receives historical information of a distributed data processing system as an input, and then generates a set of rule hint pairs based on the historical information. The QO-Advisor provides the set of rule hint pairs to a query plan optimizer, which then optimizes a query plan of an incoming query through application of a rule hint pair in the set. This application is based at least on a characteristic of the incoming query matching a portion of the rule hint pair.

### CROSS-REFERENCE TO RELATED APPLICATION(S)

This application claims priority to U.S. Provisional Patent Application No. 63/286,676, entitled “QUERY OPTIMIZER ADVISOR,” and filed on Dec. 7, 2021, the entirety of which is incorporated by reference herein.

### BACKGROUND

Query plan optimization for querying databases aims to make data accesses efficient. Some previous approaches to optimizers have tried to steer query plan choices using machine learning to learn from a given user workload different components of a query optimizer that indirectly lead to better query plan choices, but the real-world applicability of these approaches is constrained in its implementation. For instance, some prior approaches attempt to steer a query optimizer with hints over a given number of rules and associated configurations, or have extended existing solutions through random sampling to generate new rule configurations. These processes, however, are prohibitively expensive with respect to computing resources and are not able to catch performance regressions in the query plans that are generated.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods for optimization in query plans are performed by computing systems via a query optimizer advisor. A query optimizer advisor (QO-Advisor) is configured to steer a query plan optimizer towards more efficient plan choices by providing rule hints to improve navigation of the search space for each query in formulation of its query plan. The QO-Advisor receives historical information of a distributed data processing system as an input, and then generates a set of rule hint pairs based on the historical information. The QO-Advisor provides the set of rule hint pairs to a query plan optimizer, which then optimizes a query plan of an incoming query through application of a rule hint pair in the set. This application is based at least on a characteristic of the incoming query matching a portion of the rule hint pair.

Further features and advantages, as well as the structure and operation of various examples, are described in detail below with reference to the accompanying drawings. It is noted that the ideas and techniques are not limited to the specific examples described herein. Such examples are presented herein for illustrative purposes only. Additional examples will be apparent to persons skilled in the relevant art(s) based at least on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system for optimization in query plans via a query optimizer advisor, according to an example embodiment.

FIG. 2 shows a block diagram of a computing system for optimization in query plans via a query optimizer advisor, according to an example embodiment.

FIG. 3 shows a flowchart for optimization in query plans via a query optimizer advisor, in accordance with an example embodiment.

FIG. 4 shows a flow diagram of a pipeline for optimization in query plans via a query optimizer advisor, in accordance with an example embodiment.

FIG. 5 shows a flowchart for optimization in query plans via a query optimizer advisor, in accordance with an example embodiment.

FIG. 6 shows a flowchart for optimization in query plans via a query optimizer advisor, in accordance with an example embodiment.

FIG. 7 shows a data structure for feature generation in optimization of query plans via a query optimizer advisor, in accordance with an example embodiment.

FIG. 8 shows a data structure for optimization in query plans via a query optimizer advisor, in accordance with an example embodiment.

FIG. 9 shows a block diagram of an example computing device that may be used to implement embodiments.

The features and advantages of embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially,” “approximately,” and “about” modifying a condition or relationship characteristic of a feature or features of an embodiment of the disclosure, are understood to mean that the condition or characteristic is defined to be within tolerances that are acceptable for operation of the embodiment for an application for which it is intended.

If the performance of an operation is described herein as being “based on” one or more factors, it is to be understood that the performance of the operation may be based solely on such factor(s) or may be based on such factor(s) along with one or more additional factors. Thus, as used herein, the term “based on” should be understood to be equivalent to the term “based at least on.”

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures and drawings described herein can be spatially arranged in any orientation or manner. Additionally, the drawings may not be provided to scale, and orientations or organization of elements of the drawings may vary in embodiments.

In the context of the embodiments herein, e.g., for databases, a “data set” or “data file” may be stored as a “table” of data, and these terms, “tables,” “data sets,” and “data files” may be used interchangeably in the description. Such terms are also contemplated as comprising databases, or portions thereof, in embodiments.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Section II below describes example embodiments for optimization in query plans via a query optimizer advisor. Section III below describes example computing devices that may be used to implement features of the embodiments described herein. Section IV below describes additional examples and advantages, and Section V provides some concluding remarks.

### II. Example Embodiments for Query Optimizer Advisors

Methods for optimization in query plans are performed by computing systems via a query optimizer advisor and described herein. A Query Optimizer Advisor (QO-Advisor) is configured to steer a query plan optimizer towards more efficient plan choices by providing rule hints to improve navigation of the search space for each query in formulation of its query plan. QO-Advisor implementations may be realized as pipelines, processes, and/or the like.

Modern analytical workloads are highly heterogeneous and massively complex, making generic query optimizers untenable for many users and scenarios. Aspects described herein steer a query optimizer towards better plans for a given workload, and also solve operational challenges including, without limitation, making steering actions more manageable, keeping the costs of steering within budget, avoiding unexpected performance regressions in production, etc. Conceptually, the described QO-Advisor aspects externalize the query planner to a massive offline pipeline for better exploration and specialization. Because general purpose query optimization in modern cloud-based data processing systems now lacks avenues for sufficient improvements, these systems witness a wide variety of highly complex applications that are very hard to optimize globally, and yet these systems typically utilize generic query optimizers that were built for all users, scenarios, and scales. Still further, such optimizers may be tuned for generic benchmarks that often do not represent real user workloads. As a result, these general-purpose query optimizers are often far from optimal in their plan choices for a given user and a given workload. In contrast, the QO-Advisor implementations described herein are enabled to specialize cloud-based query optimizers to the needs of specific users and applications at hand, and thus optimize relevant workloads more effectively (e.g., instance optimization).

Additionally, the QO-Advisor implementations described herein solve issues with generic query optimizers while providing for understandability of optimizations, for efficiencies for use of system resources and cost management, and for avoiding performance regressions (e.g., due to inaccurate cost models). That is, QO-Advisor aspects overcome the deployment challenges noted above and steer query optimizers in an explainable, cost-effective, and safe manner. This is accomplished, in embodiments, by breaking down the steering process into smaller, incremental steps that are easily explainable and reversible, and implementing a novel model pipeline configuration where a machine learning (ML) model, e.g., a contextual bandit model, is used to significantly cut down the pre-production experimentation costs, which is followed by a cloud variability model determining performance improvements or regressions. Essentially, the QO-Advisor aspects herein allow “visibility” into the core of a query optimizer, e.g., the query planner, which has historically been seen as a black box, and the QO-Advisor externalizes it for better specialization over user workloads.

Regarding contextual bandits, these are an extension of supervised learning where the feedback is limited to the actions made by the learning algorithm. For optimization problems where enumeration is impractical, contextual bandits are a useful abstraction because they limit the evaluation burden to the actions made by the learning algorithm. Specifically, the burden of computing the quality of all plausible query plans implies supervised learning has a very high overhead, but the contextual bandit learning implementation herein has low overhead as only the query plans preferred by the learning algorithm will need to be evaluated. Contextual bandits achieve statistical guarantees similar to those of supervised learning by constructing an experimental design and then reducing it to supervised learning. However, the use of supervised learning as a subroutine implies contextual bandit learning inherits issues of supervised learning. In particular, query plan representation can have a large impact on performance. The experimental designs induced by contextual bandit algorithms are randomized; informally, good actions become increasingly more likely under the experiment design as more data accumulates, but other actions still have some likelihood despite their poor historical performance. Specific to QO-Advisor aspects, a contextual bandit algorithm will initially choose uniformly-at-random with respect to the available query plans, but as historical data accumulates it will play (what the supervised learning model indicates is) the best query plan with increasing frequency. Although the guarantees of contextual bandit learning have the same dependence on data volume as supervised learning, the effective number of data points is decimated by the number of actions per example in the worst case, which enables limiting the number of actions per example as discussed herein. These aspects of contextual bandit learning in the implementations for QO-Advisor aspects (e.g., limited evaluation requirements and informed randomization) are improvements over previous solutions for query plan optimizations.

QO-Advisor aspects may interact with other computing platforms, components, and systems during performance of functions/operations. For instance, a QO-Advisor may utilize a computational platform (or a data processing system), a modeling platform, and/or the like. In some implementations, a computational platform or a data processing system may be, or may be similar to, a large-scale distributed data processing system such as Microsoft® SCOPE platform from Microsoft Corp. of Redmond, Wash. (a scripting language “Structured Computation Optimized for Parallel Execution”). Such a computational platform may power production workloads from a wide range of products, processing petabytes of data on hundreds of thousands of machines every day. In some aspects, the computational platforms may use a SQL-like scripting language that is compiled into Direct Acyclic Graphs (DAGs) of operators. In such embodiments, computational platform scripts, commonly referred to as jobs, are composed as a data flow of one or more SQL statements that are stitched together into a single DAG by the computational platform compiler. The computational platform optimizer is implemented similarly to a traditional cascades-style query optimizer and uses a set of rules to transform a logical query plan in a top-down fashion, yet it also makes all the decisions required to produce a distributed plan. Examples of such decisions are determining how to partition the inputs or selecting the optimal amount of parallelism given the number of containers available for the job. The number of concurrent containers used by each job may be referred to as number of tokens, while the total amount of tokens used for executing a job may be called vertices. The computational platform optimizer estimates the cost of a plan using a combination of data statistics and other heuristics tuned over time. Once executed, several metrics are logged by the computational platform runtime. Common metrics of interests are job latency, vertices count, and PNhours (e.g., the sum of the total central processing unit (CPU) and input/output (I/O) time over all vertices), described in further detail below. Finally, computational platform aspects provide an “A/B” testing service infrastructure which allows to re-run jobs in a pre-production environment using different engine configurations and compare the performance of those configurations with the default configuration.

QO-Advisor aspects also advantageously utilize recurring jobs. Some deployed implementations of query and computational platforms may see more than 60% of jobs as recurring, e.g., periodically arriving template-scripts with different inputs and predicates. QO-Advisor utilizes historical information on previous executions of recurring jobs to improve future occurrences, and recurring jobs are exemplarily used as illustrative in the description of QO-Advisor functions/operations herein, however, aspects herein are not so limited as will be described below.

In some embodiments, the computational platform optimizer is a rule-based optimizer. Various computational platform implementations include different numbers of rules, but may be up to, or exceeding, 256 rules in a standard computational platform optimizer. Rules may be divided into different categories, including but without limitation: required (which must always be enabled to get valid plans), off-by-default (which are disabled by default because experimental or very sensitive to estimates), on-by-default, implementation rules, and/or the like. The default optimizer rule configuration may return sub-optimal plans for certain job instances or workloads, whereas an instance-optimized rule configuration could return better instance-optimal plans. This, for example, can be achieved by turning on an off-by-default rule, or conversely by turning off an on-by-default or implementation rule (and therefore restricting a part of the optimizer search space). However, determining instance-optimized rule configuration is a non-trivial problem. For instance, even applying sophisticated techniques to modify hints is not feasible at least because the configuration space is too big and complex: currently there are currently 256 hints in large computational platforms such as Microsoft® SCOPE platform, while there were only 48 considered in some older platforms.

To overcome the above problem, some prior platforms have analyzed large production workloads from computational platforms and attempted to apply rule signatures and job spans. For instance, a computational platform optimizer was extended to return a bit vector specifying which rules directly contributed to it on a per-plan basis to determine rule signatures (e.g., if only the first and the second rule were used during the optimization, then an illustrative rule signature could be ‘1100000000’). For the job span, given a job, a set was computed containing all rules which, if enabled or disabled, can affect the final query plan. That is, the span of a job contains all the rules that can lead to some change in the final optimized plan, and allows the exploration of rule configurations to be narrowed down heuristically by skipping ones that are unworthy. Thus, given the rule signature for a job and its span, it was possible to generate instance-optimized rule configurations returning better estimated cost and runtime metrics (e.g., latency improvements) than when using default rule configurations. The heuristic used for these configuration searches included for each job, randomly sampling a number of configurations over that job's span (e.g., 1000) following a uniform distribution and recompiling all generated samples to confront the new estimated cost returned by the optimizer against the ones from the default rule configuration. Then, for all configurations with better cost estimates, a relatively small (e.g., 10) more promising ones were picked and tested against the default configuration for validating that a better cost estimate translated into better runtime metrics. Among all the tested configurations, the one with the best runtime metrics improving over the default configuration was picked (if it existed) and applied to the next occurrence of the recurring job.

Contrastingly, aspects described herein are enabled to achieve fully-automated, instance-optimized rule configurations of computational platform jobs and overcome several difficulties related to the heuristics for steering computational platform query optimizers via QO-Advisor embodiments. Such difficulties include, without limitation, debugging difficulties, maintenance costs, and identifying regressions in performance. Instance-optimized rule configurations are generated using uniform sampling in prior computational platforms. This provides no real insight on why one configuration is better than another, and consequently, when an incident/issue is raised (e.g., because of some unexpected performance regressions) debugging is almost impossible. Moreover, the number of resources required to maintain this feature in computational platform production/deployments is not trivial, and it additionally requires specialized combinations of software and hardware. In fact, for each recurring job, 1000 different rule configurations or more may be recompiled, as well as 10 of them being tested (e.g., re-run in pre-production environment), which quickly becomes very expensive in terms of time and resources used. Still further, performance regressions are very difficult to identify upfront. There is no principled way of detecting regression or bad configurations upfront. The only guard is the estimated costs from the computational platform optimizer after recompilation (which does not identify regressions in various scenarios) and testing (which does not take into consideration the variance inherent in clusters of machines, unless it is repeated for each testing run several times).

The QO-Advisor embodiments herein enable recommendations for better search paths, via rule hints, for query plans that, when executed, significantly improve the performance of queries. The difference over prior solutions, however, is that while prior index recommendations are applied offline and appropriate indexes are created a priori, the search space recommendations are applied online during the query optimization process itself. Alternatively, and to keep the processes/aspects herein lightweight, the described QO-Advisor embodiments perform the resource heavy/intensive searching of the recommendations and generating of the appropriate rule hints for different recurring job templates in an offline pipeline. This leverages massive amounts of past telemetry that are available from computational platform jobs to explore better query plans in an offline loop and integrate the recommendations to steer the optimizer to those plans as they are subsequently executed in the future. QO-Advisor embodiments open up a core query optimizer component, e.g., the query planner, to be explored and improved upon externally via the use of past telemetry and offline compute resources. This is a major shift from traditional query planning and allows a different approach, e.g., to consider more expensive and more exhaustive search algorithms which one cannot afford during active query optimization, to observe the actual execution costs seen in the past as compared to relying purely on the estimated costs, and to do more validation offline to anticipate any unexpected query plan behavior and even improve upon it before actually deploying it to future queries. Still further, QO-Advisor aspects are configured to integrate back seamlessly with the query optimization of future queries in an automated loop, without users having to worry about or even notice the externalized query planning component. Thus, QO-Advisor aspects herein introduce a new way to conceptualize query planning that helps scale query optimizers to the complexity and challenges that are seen in modern workloads, e.g., cloud workloads.

As noted, one or more parts/portions of a QO-Advisor pipeline/process may be executed offline and periodically, e.g., daily, weekly, etc. The QO-Advisor takes as input historical information on job executions, e.g., in large scale distributed data processing system, for a specified date, in embodiments, and produces a list or set of rule hint pairs (e.g.: [job template, hints]) which are loaded into the optimizer of the data processing system. From the historical runs metadata, the QO-Advisor pipeline first generates a set of features, and then inputs the features into a recommendation task which uses a contextual bandit model to suggest up to one rule hint for each job. These rule hints are then passed to the computational platform optimizer for a recompilation run. Jobs are recompiled such that: (1) compilation errors due to the new rule settings are identified upfront; and (2) new estimated cost for the plan is determined. Recompiled jobs with the worst estimates are pruned, while for the remaining jobs, an A/B test is run through a testing/flighting service, or the like, of the data processing system. The output of testing/flighting is then provided into a validation task that applies a linear regression model. This provides a guard over performance regressions, given that it is important for production workloads. The job templates (and related hints) that pass validation, are then written into a file by a hint generation task, or the like, and loaded into the data processing system optimizer such that the generated hint will be applied at the next occurrence of the job template.

Various embodiments herein are directed to computational platforms and/or database systems, including distributed databases, distributed data processing systems, and computing centers, which may be cloud-based, such as but not limited to, data warehouses, systems for “Big Data” storage and/or analytics, enterprise systems, other database systems that store very data sets, including very large data sets, and/or the like, and while some embodiments are described in the context of compute nodes in distributed database implementations, embodiments are not so limited. Described embodiments are applicable to any type of database server implementation, such as but not limited to, PostgreSQL and SQL Server® from Microsoft Corporation of Redmond, Wash. Additionally, embodiments are described herein by way of example and for purposes of illustration, however, other implementations and architectures are also adaptable to, and contemplated for, the described embodiments and are contemplated herein.

In embodiments, a distributed database system, a distributed data processing system, and/or a data warehouse system, by way of example, may comprise multiple compute pools (e.g., across multiple physical servers, e.g., as virtual data warehouse instances within a logical server, and/or the like). A compute pool may include, without limitation, a control node (i.e., a front-end node), a distributed query processor (DQP), one or more compute nodes, and/or the like. Control nodes and associated DQPs may act as query endpoints that are responsible for producing a distributed plan for an incoming query and dividing work among a pool of compute nodes, where each compute node may be responsible for distributively processing data from one or more distributions, e.g., portions or distributions of a data set or data file, which may comprise a large, distributed table of data. Each control and compute node in the embodiments described may be configured to run/execute its own instance of a database server or the like, each of which may be assigned a resource manager identifier unique to the overall system. In embodiments, an instance of a database server may comprise various ones of control and compute “nodes”: a portion of a node(s), a node, more than one node, and/or the like.

In implementations, compute pools may share the same transaction manager node to start or commit a transaction. Additionally, queries are contemplated to be directed against a single, or multiple, databases (DBs), which may include writing across all databases within a logical server or physical servers that comprise the same transaction manager node. That is, cross-DB query support may be implicit in the described embodiments. Embodiments herein also contemplate that different compute pools are enabled to operate on the same tables of DBs within a system, where local storage of written data pages may be maintained by compute nodes for performance of functions against different DBs.

These and other embodiments will be described in further detail below, in association with the Figures, and in Sections/Subsections that follow.

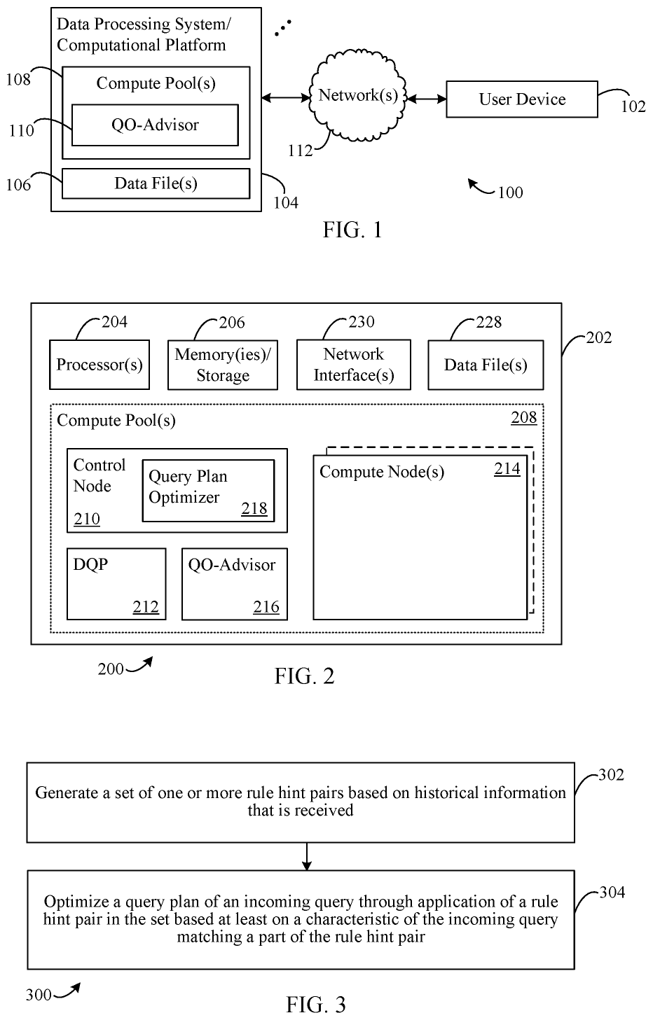

Systems, devices, and apparatuses herein may be configured in various ways for optimization in query plans via a QO-Advisor. For instance, FIG. 1 will now be described. FIG. 1 shows a block diagram of a system 100 that is configured for optimization in query plans via a QO-Advisor, according to example embodiments.

As shown in FIG. 1, system 100 includes a user device 102 and a distributed data processing system/computational platform 104 (“data processing system 104” hereinafter, generally). In embodiments, user device 102 and distributed data processing system 104 communicate with each other over a network 112. It should be noted that in various embodiments different numbers of user devices and/or data processing systems, and/or subcomponents thereof, are present. Additionally, according to embodiments, any combination of the systems and/or components illustrated in FIG. 1 are present in system 100.

Network 112 comprises different numbers and/or types of communication links that connect devices, platforms, and hosts/servers such as, but not limited to, the Internet, wired or wireless networks and portions thereof, point-to-point connections, local area networks, enterprise networks, cloud networks, and/or the like, in embodiments.

User device 102 in different embodiments is any number, type, or combination of computing devices or computing systems, including a terminal, a personal computer, a laptop computer, a tablet device, a smart phone, a personal digital assistant, a server(s), a gaming console, and/or the like, including internal/external storage devices, that are utilized to execute functions/operations described herein for interacting with a database, data warehouse, data processing system, and/or database server, such as providing queries against tables/data sets. User device 102 also includes additional components (not shown for brevity and illustrative clarity) including, but not limited to, components and subcomponents of other devices and/or systems herein, in embodiments. In some embodiments, user device 102 may comprise a computing device/system hosting a service or application that provides queries against tables/data sets.

Distributed data processing system 104 may be a database system or other type of data processing system, including distributed implementations, a data warehouse, and/or the like, and comprises one or more server computers, computing systems, and/or computing devices, which may include one or more distributed or “cloud-based” servers in embodiments. Distributed data processing system 104 may comprise one or more on-premises servers in addition to, or in lieu of, cloud-based servers, in different implementations contemplated herein. Various systems/devices herein, such as distributed dataprocessing system 104, are configured to provide services utilized by user device 102, such as business services and/or applications involving data warehousing, database hosting, and/or like. For instance, distributed data processing system 104 includes one or more compute pool(s) 108 that may each include, without limitation, a control node, a DQP, one or more compute nodes, and/or the like, as described herein. Distributed data processing system 104 also includes a query optimizer advisor 110 associated with compute pool(s) 108, as well as additional components configured to perform functions for optimization in query plans via a query optimizer advisor, as described in further detail herein, and one or more data files 106 (“data files 106” hereinafter) which may be data sets, tables, etc., as noted above. In embodiments, compute pool(s) 108 may comprise, or comprise a portion of, a computational platform described herein.

Data files 106 include databases and/or the like that comprise tables of data, in embodiments, which may be very large data files/sets such as for “Big Data” analytics and/or data warehousing. It is contemplated herein that one or more of data files 106 are to the order of petabytes, or more, in embodiments. Data files 106 may include any type of data, including relational data, organized as tables having columns for the data.

As noted above, compute pool(s) 108 may include a control node that comprises one or more server computers, server systems, and/or computing devices, such as an on-premises server(s) in addition to, or in lieu of, cloud-based servers. A control node may include an instance of a database server application and is configured to act as the query endpoint for incoming queries, to produce a distributed query plan for an incoming query in conjunction with a DQP. In embodiments, a compute node and a DQP may be logically and/or physically separate, or combined in whole/part. The distributed query plan divides work for query processing among compute nodes of compute pool(s) 108. That is, according to embodiments, a control node and a DQP are configured to receive and transform an incoming query into a set of queries that are run against distributions of a data file/data set, e.g., in parallel, via the compute nodes.

Compute nodes may each comprise one or more server computers, server systems, and/or computing devices, such as an on-premises server(s) in addition to, or in lieu of, cloud-based servers. Compute nodes may also each include an instance of a database server application, and are configured to read and/or process data from one or more distributions of large tables in performance of query execution tasks as distributed by the control node/DQP. Compute nodes may also each include a cache to locally store rows or pages of a table for faster access thereto as needed for operations of transactions thereon. In embodiments herein, compute nodes are configured to perform functions and/or operations for optimization in query plans via a query optimizer advisor as described.

Query optimizer advisor 110 may be configured to steer a query plan optimizer in optimization of a query plan at a compile time of an incoming query. Query optimizer advisor 110 may comprise, or be conceptualized as, instructions/mechanisms that pipeline generation, validation, and implementation of rule hints that guide a query plan optimizer to navigate the search space more efficiently and effectively for each query in formulation of its query plan.

While not shown for brevity and illustrative clarity, distributed data processing system 104 may include a transaction manager node configured to drive versioning and semantics for query transactions in distributed systems. For example, a transaction manager node is configured to version, or uniquely identify, incoming queries that alter or modify data (i.e., queries that are not read-only) and data that is altered/modified by such queries. A transaction manager node is also configured to supervise and maintain active, commit, and abort information for such queries.

As noted above, data system 104 may include one or more distributed or “cloud-based” servers, in embodiments. That is, data system 104 may be a network, or “cloud,” implementation for applications and/or services associated with hosting databases and/or data warehousing in a network architecture/cloud platform. A cloud platform includes a networked set of computing resources, including servers, routers, etc., that are configurable, shareable, provide data security, and are accessible over a network such as the Internet, according to embodiments. Cloud applications/services for hosting databases and/or data warehousing are configured to run on these computing resources, often atop operating systems that run on the resources, for entities that access the applications/services, locally and/or over the network. A cloud platform is configured to support multi-tenancy as noted above, where cloud platform-based software services multiple tenants, with each tenant including one or more users who share common access to certain software services and applications of the cloud platform, as noted herein. Furthermore, a cloud platform is configured to support hypervisors implemented as hardware, software, and/or firmware that run virtual machines (emulated computer systems, including operating systems) for tenants. A hypervisor presents a virtual operating platform for tenants.

While a distributed data processing system, database system, or data warehouse (e.g., distributed data processing system 104) is shown in system 100 for non-limiting purposes of description and illustration, in various embodiments, alternate implementations for data/database hosting and/or the like are also contemplated herein.

Referring now to FIG. 2, a block diagram of a system 200 is shown for optimization in query plans via a query optimizer advisor, according to an example embodiment. System 200 as exemplarily illustrated and described is configured to be an embodiment of distributed data processing system 104 of system 100 in FIG. 1. That is, system 200 is illustrated as being configured to perform operations of a computational platform, a database system, a data processing system, a data warehouse, etc., based at least on the embodiments described herein. System 200 is described as follows.

System 200 includes a computing system 202 which is any type of server or computing system/computational platform, as mentioned elsewhere herein, or as otherwise known, including without limitation cloud-based systems, on-premises servers, distributed network architectures, a data warehouse or portions thereof, and/or the like. As shown in FIG. 2, computing system 202 includes one or more processors (“processor”) 204, one or more of a memory and/or other physical storage device (“memory”) 206, as well as one or more network interfaces (“network interface”) 230. Computing system 202 also includes a compute pool(s) 208 (which may be any number of compute pools, and which may be comprised of one or more servers, virtual data warehouse instances of a data warehouse system, and/or the like, in embodiments). It should be noted that while not shown for brevity and illustrative clarity, system 200 may also include a transaction manager or a transaction manager node, a Directed Acyclic Graph (DAG) generator, as well as other components generally utilized for database and data warehouse implementations, as would be understood by persons of skill in the relevant art(s) having the benefit of this disclosure. Also illustrated for system 200 is one or more data file(s) 228 (also “data files 228” hereinafter), which may be an embodiment of data files 106 of FIG. 1 and may include one or more user tables, data sets, data files, etc., of user data against which transactions of queries are performed.

Processor 204 and memory 206 may respectively be any type of processor circuit(s)/system(s) and memory that is described herein, and/or as would be understood by a person of skill in the relevant art(s) having the benefit of this disclosure. Processor 204 and memory 206 may each respectively comprise one or more processors or memories, different types of processors or memories (e.g., a cache(s), temporary database memory, etc., for versioning and/or query processing), remote processors or memories, and/or distributed processors or memories. Processor 204 may be multi-core processors configured to execute more than one processing thread concurrently. Processor 204 may comprise circuitry that is configured to execute computer program instructions such as, but not limited to, embodiments of compute pool(s) 208, including one or more of the components thereof as described herein, which may be implemented as computer program instructions, or alternative as hardware, as described herein, and stored in memory 206.

Memory 206 includes volatile storage portions such as a random access memory (RAM) and/or persistent storage portions such as disks/hard drives, non-volatile RAM, caches, and/or the like, to store or be configured to store computer program instructions/code for optimization in query plans via a query optimizer advisor as described herein, as well as to store other information and data described in this disclosure including, without limitation, data sets, tables of information associated with queries, indexes, lists or tables of data version information, different types of metadata (including but not limited to historical metadata of past jobs executed, features/featurized data, page tables, etc.), timestamps, and/or the like, in different embodiments. For instance, computing system 202 may store data/information in memory 206, e.g., as on-disk storage, in caches of systems and/or components described herein, and/or the like. In embodiments, such data, types of metadata, and/or information may be stored in a storage external to computing system 202, and may be available for sharing/use by computing system 202 and/or other systems (e.g., multiple pools of compute/processing nodes, external systems, as described herein, etc.) via a network or storage interface. Memory 206 may comprise internal and/or external portions in embodiments.

Network interface 230 may be any type or number of wired and/or wireless network adapter, modem, etc., configured to enable system 200, including computing system 202, to communicate intra-system with components thereof, as well as with other devices and/or systems over a network, such as communications between computing system 202 and other devices, systems, hosts, of system 100 in FIG. 1, including systems that store data sets, user devices, compute nodes, and/or the like, over a network such as network 112.

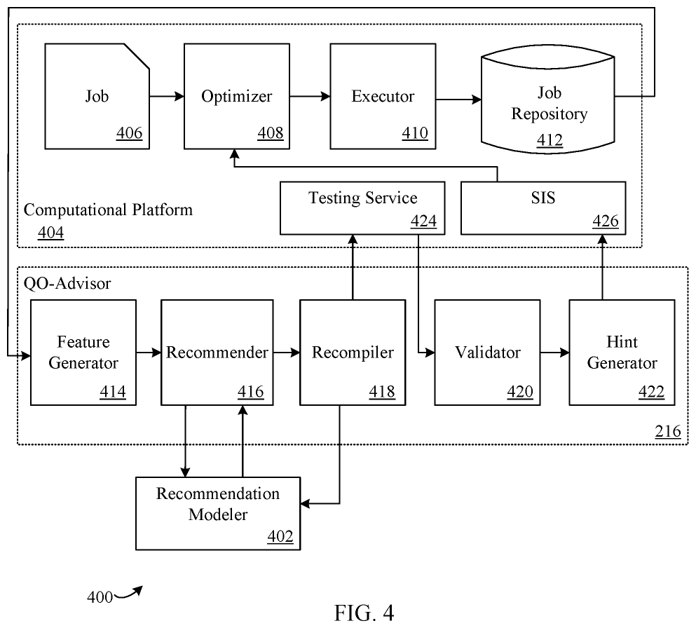

System 200 also includes additional components (not shown for brevity and illustrative clarity) including, but not limited to, components and subcomponents of other devices and/or systems herein, an operating system(s), and/or those described below with respect to FIG. 4, according to embodiments.

Compute pool(s) 208 may be an embodiment of compute pool(s) 108 in FIG. 1, as described above. In the illustrated embodiment, compute pool(s) 208 includes a control node 210, a distributed query processor (DQP) 212, one or more compute node(s) 214, and a QO-Advisor 216, although embodiments contemplate different numbers of one or more of these components in various implementations. Likewise, one or more of compute pool(s) 208 may be present computing system 202.

Control node 210 may comprise any database server application, in addition to processors and memory, described above, and operate as a front end, or a query endpoint, in embodiments, that receives queries from user devices, services, applications, and/or the like. Control node 210 may include a data definition language (DDL) engine and a query optimizer/query plan optimizer 218, in embodiments. A DDL engine is configured to execute statements to create, modify, and delete tables, indexes, and relationships in a data set/data file, e.g., based at least on an incoming query. In embodiments, a DDL engine is configured to execute statements to create, modify, and/or delete rows in tables, tables themselves, lists, arrays, and/or other data structures that are generated in performance of the query transactions.

Query plan optimizer 218 is configured to generate query plans for execution of incoming queries against tables, data sets, etc. based at least on the incoming queries and other information, e.g., cardinality estimates, etc. In embodiments, query plan optimizer may comprise a compiler, or may be associated with a compiler of control node 210, which may be a portion of a computational platform. To begin query execution, control node 210 may communicate with a transaction manager node (not shown) and provide information associated with a query (e.g., an API call responsive to receiving the query) such that the transaction manager node is enabled to assign a transaction start identifier (i.e., a begin sequence number) for the query, and query plan optimizer 218 generates a query plan for the query where, according to embodiments, QO-Advisor 216 guides or steers query plan optimizer 218 in optimization of query plans at compile times of incoming queries. In embodiments, this may include, without limitation, by providing rule hints that modify rule configurations used by query plan optimizer 218 in query plan generation to navigate the search space more efficiently and effectively. Query plan optimizer 218 is configured to optimize a query plan of an incoming query through application of a rule hint pair(s) (each comprising a template identifier and a rule hint). Applying the rule hint pairs is based at least on a characteristic of the incoming query, e.g., a template portion of a query, matching the template identifier portion of a rule hint pair, in embodiments.

QO-Advisor 216 is configured to receive historical information as an input and ultimately generate/validate the rule hint pairs. The historical information may comprise past job execution metadata of system 200. QO-Advisor 216 is configured to generate a set of one or more rule hint pairs based on the historical information that is received, and to provide the set to query plan optimizer 218 once validated. More specifically, according to embodiments, QO-Advisor 216 may featurize the historical information to generate features, and identify/recommend a rule hint for each job based at least on a contextual bandit algorithm that takes as an input the features associated with the historical information. QO-Advisor 216 is configured to perform, as part of the pipeline, an offline and periodic execution of one or more operations thereof. Additionally, QO-Advisor 216 is configured to recompile a past job associated with the job execution metadata based at least on rule hints of the identified rule hint pairs, to identify errors during a recompilation that correspond to rule hints, to determine an estimated plan cost for each recompilation, to validate any recompilations having respective estimated plan costs, which satisfy a cost condition, via a linear regression model that identifies performance regressions, and/or to store the set of rule hint pairs in a data structure that is provided to query plan optimizer 218.

In embodiments, a rule hint of a rule hint pairs modifies a single rule utilized by query plan optimizer 218 for a given job, portion of a query, query, and/or the like, although other embodiments contemplate the modification of multiple rules.

DQP 212 may include subcomponents such as a deserializer, a Directed Acyclic Graph (DAG) generator, a workload manager, and/or the like in embodiments, and may be configured to orchestrate a query task DAG across large numbers, e.g., thousands, of compute nodes at petabyte-scale reliably. A deserializer is configured to deserialize requests for distributed query processing on data set distributions, received from control node 210, and to provide its output to the DAG generator which in turn is configured to generate a DAG, such as a static DAG that outlines process dependencies and operations for performing distributed execution of query tasks/transactions at ones of compute node(s) 214. DAGs are provided from the DAG generator to the workload manager which is configured to assign ones of compute node(s) 214 to perform the tasks/transactions in accordance with the embodiments herein for optimization in query plans via a query optimizer advisor. As one example, from the raw features and plans contained in a view file, a DAG may be transformed into a tree, in embodiments, by generating a super root node that aggregates all the features and information contained in the sub-query trees comprising a job.

Control node 210 may be a logically or physically separate entity from other components of computing system 202, and DQP 212 may be a logically or physically separate entity from other components of computing system 202. For example, in some embodiments, control node 210 and DQP 212 may be implemented in different physical or logical server hosts that are communicably linked. In such embodiments, DQP 212 may comprise a separate server node while control node 210 comprises its own server. Likewise, QO-Advisor 216 may be a logically or physically separate entity from other components of computing system 202, such control node 210 and/or DQP 212, in some embodiments, or may be logically or physically coupled in other embodiments.

Compute node(s) 214 may comprise any database server application, in addition to processors and memory described above, and operate as a back end, in embodiments, that receives portions of distributed query tasks/transactions from control node 210 and/or DQP 212. One or more compute node(s) 214 may be present in given embodiments, and each of compute node(s) 214 may include a data definition language (DDL) engine and a query plan optimizer (e.g., as, or similar to, an instance of query plan optimizer 218), in embodiments, as described above. Compute node(s) 214 is configured to operate in accordance with embodiments for optimization in query plans via a query optimizer advisor, as described herein. While not shown for brevity and illustrative clarity, compute node(s) 214 may include a plurality of hardware and/or software components: a buffer pool, a file control block, a buffer pool extension, an extension page file, a page table, a staging buffer, etc. In embodiments, one or more of compute node(s) 214 may respectively include one or more of these components.

Further details regarding the operations and configurations of system 200, and its various sub-components, are provided in the embodiments herein, including those shown in the instant Figures, discussed in their associated descriptions.

FIG. 3 shows a flowchart 300 for optimization in query plans via a query optimizer advisor, in accordance with an example embodiment. Further structural and operational examples will be apparent to persons skilled in the relevant art(s) based at least on the following descriptions. Flowchart 300 is described as follows with respect to system 200 of FIG. 2.

Flowchart 300 begins at step 302. In step 302, a set of one or more rule hint pairs is generated based on historical information that is received. For instance, historical information is received as an input, the historical information comprising job execution metadata of a distributed data processing system, and a set of one or more rule hint pairs is generated based on the historical information that is received. As described above, QO-Advisor 216 of computing system 202 of system 200 in FIG. 2 is configured to perform step 302. Additionally, as described above, QO-Advisor 216 may be configured to perform additional functions and operations as part of, or prior to, generating the set of rule hint pairs. Further details regarding such performance are provided herein as well as in the Figures.

In step 304, a query plan of an incoming query is optimized through application of a rule hint pair in the set based at least on a characteristic of the incoming query matching a part of the rule hint pair. For example, a portion of the set is provided to a query plan optimizer, and a query plan of an incoming query is optimized, via the query plan optimizer, through application of at least one of the rule hint pairs in the portion of the set, the application being based at least on a characteristic of the incoming query matching a portion of the at least one of the rule hint pairs. As described above, QO-Advisor 216 is enabled and configured to provide rule hint pairs to query plan optimizer 218 to guide in the optimization of a query plan for an incoming query, e.g., at compile time. The rule hint pairs may be provided in a file or data structure that is created in the pipeline, as described above. Guidance to query plan optimizer 218 for optimization may be provided via application of a rule hint pair, e.g., turning a rule on or off, for a query portion that is based on or that comprises a template matching the template identifier corresponding to the rule hint of the pair. Further details regarding such performance are provided herein.

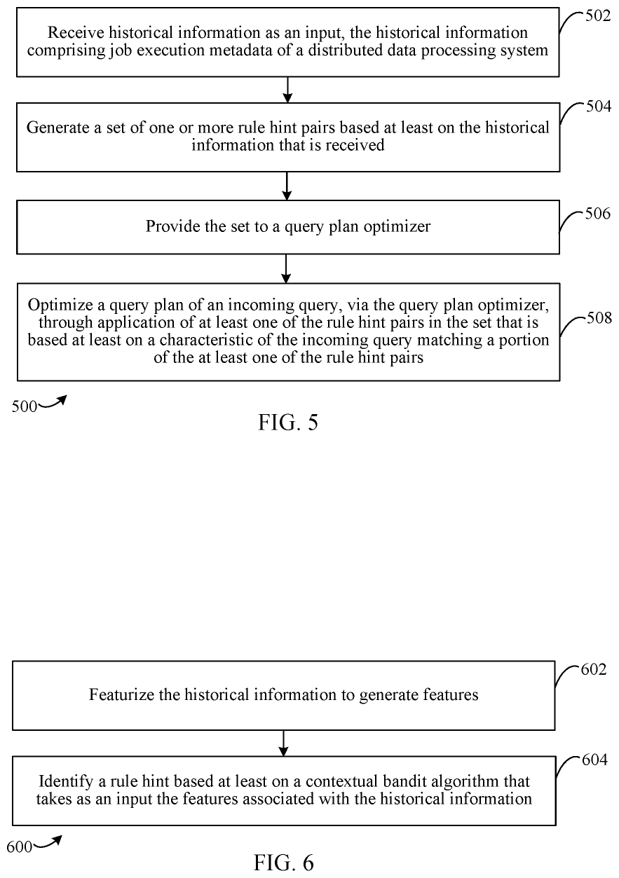

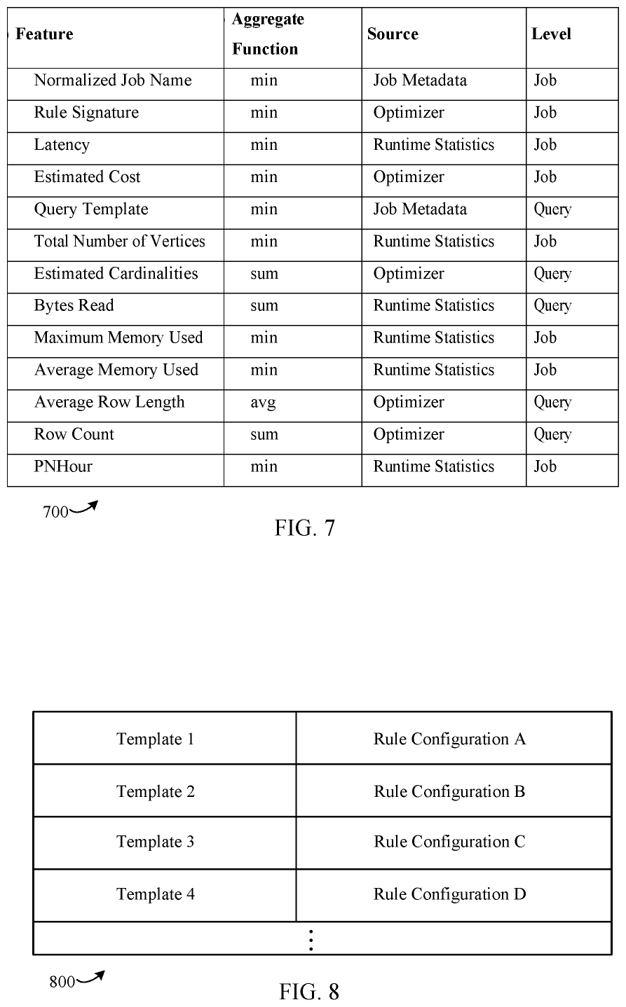

FIGS. 4-7 will now be described. FIG. 4 shows a flow diagram 400 of a pipeline for optimization in query plans via a query optimizer advisor, and FIG. 5 shows a flowchart 500 for optimization in query plans via a query optimizer advisor, in accordance with example embodiments. FIG. 6 shows a flowchart for optimization in query plans via a query optimizer advisor, and FIG. 7 shows a data structure for feature generation in optimization of query plans via a query optimizer advisor, in accordance with example embodiments.

In the illustrated embodiment, flow diagram 400 of FIG. 4 includes QO-Advisor 216 of system 200 in FIG. 2, although implementations are not so limited. In an embodiment, flowchart 500 of FIG. 5 and flowchart 600 of FIG. 6 may be implemented by system 200, e.g., via QO-Advisor 216 of shown in FIG. 2, although methods are not limited to that implementation. Accordingly, flowchart 500 and flowchart 600 will be exemplarily described with continued reference to FIG. 2, as well as to FIG. 4, and flowchart 600 may be an embodiment of flowchart 500. Other structural and operational embodiments will be apparent to persons skilled in the relevant art(s) based on the discussion regarding flowchart 500, flowchart 600, and system 200 of FIG. 2.

FIG. 4 illustrates how the pipeline of QO-Advisor 216 described herein may interact with a computational platform 404 and steer the search space for optimizing query plans. As mentioned above, the QO-Advisor aspects are illustrated as a pipeline, as in flow diagram 400, which is recurrently triggered periodically, e.g., daily, weekly, etc. The QO-Advisor pipeline takes as an input(s) historical metadata for a given day and returns a list of job template identifiers and rule hint pairs. These rule hint pairs are consumed by the computational platform optimizer such that every time a job matching one of the template identifiers is found, the provided rule hint is used at compile time to steer the query optimizer.

A distinction compared to previous approaches is that QO-Advisor embodiments do not provide full rule configurations, but rather are configured to amend the default computational platform rule configuration by turning on or off a single rule at a time. Such an approach allows for several improvements: (1) the search space is much smaller with single rule flips and therefore easier to manage and less expensive to maintain; (2) in case of performance regression, one single rule change is manageable and can be reverted compared to arbitrary changes to the rule configurations; and (3) this simpler approach is easier to control in production settings, therefore better for building confidence with teams during deployment.

The exemplary QO-Advisor pipeline in flow diagram 400 of FIG. 4 is illustrated as comprising five components or portions for different operations: feature generation, recommendation, recompiling, validation, and hint generation. Additionally, the exemplary QO-Advisor pipeline in flow diagram 400 utilizes three services: a recommendation modeler 402 (e.g., such as Azure® Personalizer of Microsoft Corp.); as well as services of computational platform 404: a testing service 424 and a statistics/insights service (SIS) 426 (e.g., such as Flighting Service and Stats and Insight Service from Microsoft® SCOPE, respectively). Computational platform 404 comprises, inter alia, an optimizer 408 and an executor 410 which respectively optimize and execute jobs such as job 406 and store data and information therefor, including job metadata, in a job repository 412. The specific configuration and operation of various components in computational platform 404 may be implementation-specific in different embodiments, as noted herein, and is conceptually illustrated via optimizer 408, executor 410, and job repository 412 for purposes of description with respect to operations and functions of the pipeline for QO-Advisor 216.

The exemplary QO-Advisor pipeline, as shown and as described below, moves from naïve to informed experimental design, learns over estimates rather than runtime metrics, and utilizes models to avoid performance regressions. Uniform sampling over a configuration space generated by a job span is expensive to maintain as it requires the generation of several configurations, the majority of which are discarded. In contrast to this approach taken by prior solutions, the QO-Advisor aspects herein provide a more principled approach whereby a contextual bandit model is trained over features extracted from the historical runs, which allows a decreased number of required re-compilations and testing/flighting runs (reducing resources required to generate query plans). Additionally, learning over estimates rather than runtime metrics over query execution times, as in prior attempts at solutions, allows for learning that is feasible. Given the scale of existing computational platforms, prior attempts at learning were simply not possible. Existing computational platforms execute hundreds of thousands of jobs spanning hundreds of thousands of machines daily, whereby re-executing even a small fraction of them can be prohibitively expensive with respect to time and computing resources. Thus, QO-Advisor aspects learn rule configurations over the estimated costs output by computational platform optimizers, while maintaining a balance between accuracy of learning and feasibility of application at large scales. Moreover, aspects herein model the QO-Advisor pipeline to avoid performance regressions. The QO-Advisor learned model suggests new rule configurations by predicting the eventual improvement on estimated costs. QO-Advisor aspects utilize a validation model that is applied after the contextual bandit model, and the goal of the second model is to make sure that the selected rule configuration will not create performance regressions after execution. To gather runtime measurements, testing/flighting data is utilized over only a small number of jobs, and under a tight budget that is proportional to how strictly avoidance of performance regressions is desired.

Referring also now to FIG. 5, flowchart 500 begins with step 502. In step 502, historical information is received as an input, the historical information comprising job execution metadata of a distributed data processing system. For example, historical information that includes job execution metadata is provided from job repository 412 of computational platform 404 to QO-Advisor 216. The historical information includes information and job execution metadata for some or all of a plurality of jobs executed by computational platform 404 (e.g., on a daily basis). The historical information may be provided to a feature generator 414 of QO-Advisor 216 specifically, and may represent a denormalized workload view in embodiments.

Referring also now to FIG. 6, flowchart 600 begins with step 602, in which the historical information is featurized to generate features. Feature generator 414 is configured to generate features from the historical information, e.g., as follows. In some aspects, this includes generating a span for all jobs for which historical information was provided in step 502 above, returning features necessary for the training of downstream models described herein. For job span generation, a span algorithm implements a heuristics search whereby, for each job, rules are iteratively turned off such that new rules having an effect on a final plan can be discovered. Starting from the original rule configuration for a job, all the off-by-default rules are turned on, while all the on-by-default and implementation rules that appear in the rule signature are turned off. Then, this new rule configuration is passed to optimizer 408 for a re-compilation pass. After re-compilation, a new rule signature with new rules to be subsequently used is obtained. Next, all the newly used (on-by-default, off-by-default or implementation rules) are again turned off, and the new configuration is run through optimizer 408. This process is repeated until a fixed point is reached. All jobs that have an empty span (e.g., the heuristics of the span algorithm is not able to find any modification to the default rule configuration) are not considered further by QO-Advisor 216.

Regarding feature aggregation, each job may execute as a script which can contain one or more queries. Therefore, for each job, the optimized plan may be a DAG of operators (instead of a single tree as is common for relational database plans), with one or more output nodes, one for each resulting dataset. Each output node can be seen as the root of a tree, whereby optimizer 408 and executor 410 generate statistics (e.g., features) per tree, while other statistics are generated per script.

Referring also now to FIG. 7, example of these per-tree features and job level statistics are shown. By utilizing DAGs instead of trees, each job may be a part of different templates, as template information is generated per-query tree and not per-job script. Additionally, because QO-Advisor 216 is configured to execute at the job granularity (and similarly, hints can be provided to computational platform 404 optimizer 408 at the job level), features generated by computational platform 404 as part of historical information for jobs may be formatted to a configuration that is preferred for proper operation of QO-Advisor 216. For instance, from the raw features and plans contained in the view file from job repository 412, DAGs can be transformed into trees by generating a super root node. Super root nodes aggregate all the features and information contained in the sub-query trees composing a job. Features are aggregated in two different ways: (1) following their semantics, e.g., doing ‘sum’ over estimated cardinalities, and ‘avg’ over average row length; and (2) for plan level features as well as for template-level features, take the ‘min.’ FIG. 7 illustrates features generated at this step of the pipeline for QO-Advisor 216, as well as the related aggregate function. After this step, all features are job level and properly aggregated. Then, the span information is attached and the result is fed back to a recommender 416, which is described below.

Referring again to FIG. 6, flowchart 600 continues with step 604 in which a rule hint is identified based at least on a contextual bandit algorithm that takes as an input the features associated with the historical information. For instance, aspects provide for recommender 416, e.g., in conjunction with recommendation modeler 402, to perform step 604. As noted above, a contextual bandit model may be utilized in formulating recommendations for rule flips (e.g., turn off an on-rule or turn on an off-rule) for a specific job. More specifically, each action flips a rule in the job span. Featurization of the actions is performed using a rules identifier and rules category information as introduced above. The context may include the features illustrated in FIG. 7 generated from the previous step of the QO-Advisor 216 pipeline, in addition to the job span, which are received by recommender 416 from feature generator 414 and provided to recommendation modeler 402. The reward realized by this approach is the relative change in terms of estimated cost to optimizer 408, e.g., the ratio between estimated cost in the default setting over the estimated cost after re-compilation with a recommended rule flip. The contextual bandit optimization is to maximize the reward: if a rule flip leads to a greater reward, the estimated cost after recompilation will become smaller, so that a plan with lower estimated cost is found. The range of the ratio is clipped so that extreme values do not overly skew the recommendation model. The clipped delta is then fed back to the contextual bandit model as the reward.

For contextual bandit learning, an off-policy learning approach may be utilized, where reward information is gathered using a uniform-at-random policy, but for the subsequent steps, a learned contextual bandit policy is used. This accelerates learning by inducing a maximally informative training dataset (at the cost of doubling the number of rule configurations test compilations). Because job recompilations are relatively inexpensive this is an acceptable trade-off that is implemented in some embodiments.

Recommendation modeler 402 uses the contextual bandit approach described herein to predict and learn under a specific problem scenario. Recommendation modeler 402 allows for improved development in many scenarios compared to ad-hoc solutions, at least because recommendation modeler 402: (1) is configured to automatically handle many to all aspects of model management, fault-tolerance, and high availability; (2) it logs with high fidelity enabling counter-factually policy evaluation; and (3) it is configured to adhere to compliance and security settings for various platforms/environments. Recommendation modeler 402 provides determined rule recommendations back to recommender 416, which passes the rule recommendations on to a recompiler 418.

Referring still to FIG. 4, recompiler 418 receives the rule recommendations noted above, for a select number of jobs, and recompiles those jobs for validation via testing service 424. In the previous steps, the rule flips (actions) generated by the contextual bandit model at recommendation modeler 402 were evaluated. However, using estimated costs alone may lead to performance regressions in some scenarios due to the variability inherent in cloud computing systems, which makes cost estimation incredibly difficult. However, as the variability problem is more severe for the job latency metric and lesser so for the PNhours metric (computed as the sum between CPU time and I/O time), the variability of I/O time is bounded as data read and data written remain constant. Therefore, variance in clusters can be so high that it makes hard to infer improvements in the runtime reliably and programmatically, without having to execute each job several times, and the total amount of data read and data written are good predictors for whether a rule flip introduces improvement or not (intuitively, if with the new configuration a job reads and writes less data, this will likely translate into better runtime). In order to gather information about data read, data written, and other indicators, testing service 424 of computational platform 404 is utilized to test the rule flips in a pre-production environment.

Thus, given a list of jobs and their related recommended actions, the estimated costs (over the recompiled plans with the rule configurations embedding the flips suggested by the model) are utilized to heuristically select which jobs to test/flight. Testing/Fighting jobs is not just expensive, but is also a very large source of resource and time consumption in optimization of query plans. Therefore, a limited budget of resources/machines are concurrently used for testing/flighting with set thresholds on (1) the maximum flighting time for each job (e.g., 24 hours); (2) the total time budget for flighting; and (3) the delta among the estimated cost from recompilation, and the default one. Additionally, aspects allow for not all jobs that reach the recompile step for recompiler 418 be tested/flighted, but instead a representative job per template (e.g., picked randomly or otherwise) may be selected. That is, intuition here is that jobs with the same template are composed by the same queries, and therefore it is not necessary to test/flight all of them because they have the same plans and eventually the same rule flip. Also, jobs with lower estimated costs may be tested/flighted first, such that if the total time budget elapses, learning is still performed, and some suggestions can be provided even if completing the testing/flighting process in full does not occur.

Interaction of QO-Advisor 216 with testing service 424 may be performed through a simple queue of fixed size, where for each job being tested/flighted, testing service 424 can return several different outcomes, such as: (1) failure (e.g., the job information or the input data expired); (2) timeout; (3) filtered (e.g., if the job belongs to certain classes of jobs that are not supported by testing service 424); (4) success; etc. In some aspects, only the jobs/templates that return with success are passed to the next step in the pipeline

The results of testing service 424 are provided back to QO-Advisor 216 and a validator 420 for validation, e.g., to catch possible regressions before running the new rule configuration in production. In validation, a linear regression model may be run by validator 420 that learns the PNhours delta given the per job total ‘data read’ and ‘data written’ features returned by testing service 424 based on the working assumption that if a job reads and writes less data, then it is likely that the PNhours will be reduced (despite the variance inherent in the cluster). To train this supervised validation model, a random subset of the jobs is tested by testing service 424 over a period of time (e.g., 14 days) to gather a dataset of results. The data points may be indexed by their timestamps, so that the dataset may be split by date to generate a training set (e.g., data in first week) and a testing set (data in a second week), in order to test whether the trained model can generalize to other dates temporally.

The output of the validate model is then compared against a pre-determined safety threshold by validator 420 such that only when the PNhours delta is at or below this threshold is a confidence with running the chosen action in production met (without causing significant regressions). The threshold can be increased or decreased based on how aggressive with respect to the delta the system should be. For example, with workloads running in production, a threshold may be set to −0.1, meaning that, for a particular job, if the expected reduction in PNhours is at least 10%, the job passes the validation by validator 420.

Referring also now back to FIG. 5 and flowchart 500, in step 504, a set of one or more rule hint pairs is generated based at least on the historical information that is received. For instance, a hint generator 422 of QO-Advisor 216 is configured to generate the set of rule hint pairs, which are based at least on the historical information as described through the pipeline process above. In step 504, the validated pairs (job templates, new rule configuration) are gathered and exploded by applying the same configuration to all jobs belonging to the same template, via hint generator 422. The output is then saved by hint generator 422 to a file in a pre-defined format for SIS 426 of computational platform 404, and this file is uploaded to in SIS 426.

In step 506, the set is provided to a query plan optimizer. For example, SIS 426 enables deploying models and configurations in computational platform 404 as SIS 426 manages versioning and validates the format before installing them in optimizer 408 of computational platform 404. In some aspects, SIS 426 picks the file containing jobs and related rules configurations, and applies them as hints to optimizer 408 each time a new instance of the same job template is submitted in the future. In some embodiments, hint generator 422 may provide the set to optimizer 408.

In step 508, a query plan of an incoming query is optimized via the query plan optimizer through application of at least one of the rule hint pairs in the set that is based at least on a characteristic of the incoming query matching a portion of the at least one of the rule hint pairs. For example, as noted above, SIS 426 may pick the file containing jobs and related rules configurations and apply them as hints to optimizer 408 each time a job with a known or matching template is submitted.

FIG. 8 shows a data structure 800 for optimization in query plans via a query optimizer advisor, in accordance with an example embodiment. In FIG. 8, data structure 800 may be a file, as noted above with respect to step 504, step 506, and step 508, which may include pairs of rule configurations that are linked to associated templates, and which may uploaded to and stored in SIS 426. For example, data structure 800 illustrates “Template 1” being linked to “Rule Configuration A” corresponding to a first query, “Template 2” being linked to “Rule Configuration B” corresponding to a second query, “Template 3” being linked to “Rule Configuration C” corresponding to a third query, and “Template 4” being linked to “Rule Configuration D” corresponding to a fourth query, etc. While four template/rule pairs are shown in data structure 800, it should be understood that more or fewer may be present in files for various aspects herein.

When a job is subsequently received by a computational platform, e.g., as shown by a job represented as job 406 submitted to computational platform 404 in FIG. 4, SIS 426 is configured to select a file, e.g., data structure 800, from one or more stored files based at least on a query(ies) in the job matching a template in the file. For instance and as an example/illustrative scenario, when job 406 submitted to computational platform 404, optimizer 408 (or another component of computational platform 404) determines that job 406 includes one or more queries, and in this scenario three different queries are determined to be present in job 406. SIS 426 determines that two of the three queries in job 406 match templates that are present in data structure 800: one query matches Template 1 and another query matches Template 4. Accordingly, SIS 426 provides Rule Configuration A and Rule Configuration D to optimizer 408 as hints for the respective queries matching Template 1 and Template 4, which allow for optimization of those queries without performance regressions.

### III. Example Computing Device Embodiments

Embodiments described herein may be implemented in hardware, or hardware combined with software and/or firmware. For example, embodiments described herein may be implemented as computer program code/instructions configured to be executed in one or more processors and stored in a computer readable storage medium. Alternatively, embodiments described herein may be implemented as hardware logic/electrical circuitry.

As noted herein, the embodiments described, including but not limited to, system 100 in FIG. 1 and system 200 in FIG. 2, along with any components and/or subcomponents thereof, as well any data structures, and operations and portions of flowcharts/flow diagrams described herein and/or further examples described herein, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), an application specific integrated circuit (ASIC), a trusted platform module (TPM), and/or the like. A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Embodiments described herein may be implemented in one or more computing devices similar to a mobile system and/or a computing device in stationary or mobile computer embodiments, including one or more features of mobile systems and/or computing devices described herein, as well as alternative features. The descriptions of computing devices provided herein are provided for purposes of illustration, and are not intended to be limiting. Embodiments may be implemented in further types of computer systems, as would be known to persons skilled in the relevant art(s).

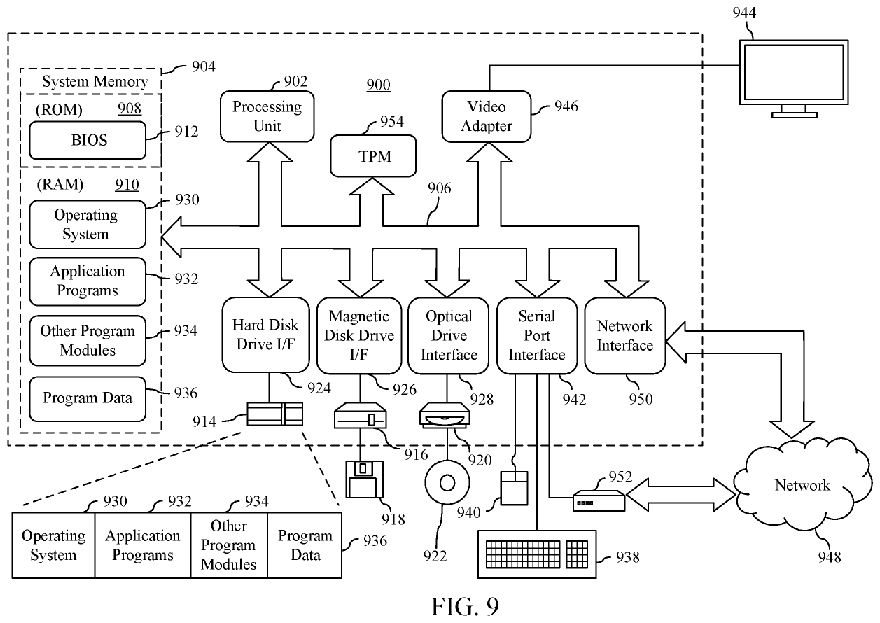

FIG. 9 depicts an exemplary implementation of a computing device 900 in which embodiments may be implemented. For example, embodiments described herein may be implemented in one or more computing devices or systems similar to computing device 900, or multiple instances of computing device 900, in stationary or mobile computer embodiments, including one or more features of computing device 900 and/or alternative features. The description of computing device 900 provided herein is provided for purposes of illustration, and is not intended to be limiting. Embodiments may be implemented in further types of computer systems, servers, and/or clusters, etc., as would be known to persons skilled in the relevant art(s).

As shown in FIG. 9, computing device 900 includes one or more processors, referred to as processor circuit 902, a system memory 904, and a bus 906 that couples various system components including system memory 904 to processor circuit 902. Processor circuit 902 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 902 may execute program code stored in a computer readable medium, such as program code of operating system 930, application programs 932, other programs 934, etc. Bus 906 represents one or more of any of several types of bus structures, including a memory bus or memory controller, a peripheral bus, an accelerated graphics port, and a processor or local bus using any of a variety of bus architectures. System memory 904 includes read only memory (ROM) 908 and random access memory (RAM) 910. A basic input/output system 912 (BIOS) is stored in ROM 908.

Computing device 900 also has one or more of the following drives: a hard disk drive 914 for reading from and writing to a hard disk, a magnetic disk drive 916 for reading from or writing to a removable magnetic disk 918, and an optical disk drive 920 for reading from or writing to a removable optical disk 922 such as a CD ROM, DVD ROM, or other optical media. Hard disk drive 914, magnetic disk drive 916, and optical disk drive 920 are connected to bus 906 by a hard disk drive interface 924, a magnetic disk drive interface 926, and an optical drive interface 928, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 930, one or more application programs 932, other programs 934, and program data 936. Application programs 932 or other programs 934 may include, for example, computer program logic (e.g., computer program code or instructions) for implementing embodiments described herein, such as but not limited to, system 100 in FIG. 1 and system 200 in FIG. 2, along with any components and/or subcomponents thereof, as well any data structures, and operations of the flowcharts/flow diagrams described herein, including portions thereof, and/or further examples described herein.

A user may enter commands and information into the computing device 900 through input devices such as keyboard 938 and pointing device 940. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 902 through a serial port interface 942 that is coupled to bus 906, but may be connected by other interfaces, such as a parallel port, game port, or a universal serial bus (USB).

A display screen 944 is also connected to bus 906 via an interface, such as a video adapter 946. Display screen 944 may be external to, or incorporated in computing device 900. Display screen 944 may display information, as well as being a user interface for receiving user commands and/or other information (e.g., by touch, finger gestures, virtual keyboard, etc.). In addition to display screen 944, computing device 900 may include other peripheral output devices (not shown) such as speakers and printers.

Computing device 900 is connected to a network 948 (e.g., the Internet) through an adaptor or network interface 950, a modem 952, or other means for establishing communications over the network. Modem 952, which may be internal or external, may be connected to bus 906 via serial port interface 942, as shown in FIG. 9, or may be connected to bus 906 using another interface type, including a parallel interface.

TPM 954 may be connected to bus 906, and may be an embodiment of any TPM, as would be understood by one of skill in the relevant art(s) having the benefit of this disclosure. For example, TPM 954 may be configured to perform one or more functions or operations of TPMs for various embodiments herein.

As used herein, the terms “computer program medium,” “computer-readable medium,” “computer-readable storage medium,” and “computer-readable storage device,” etc., are used to refer to physical hardware media. Examples of such physical hardware media include the hard disk associated with hard disk drive 914, removable magnetic disk 918, removable optical disk 922, other physical hardware media such as RAMs, ROMs, flash memory cards, digital video disks, zip disks, MEMs, nanotechnology-based storage devices, and further types of physical/tangible hardware storage media (including memory 920 of FIG. 9). Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 932 and other programs 934) may be stored on the hard disk, magnetic disk, optical disk, ROM, RAM, or other hardware storage medium. Such computer programs may also be received via network interface 950, serial port interface 942, or any other interface type. Such computer programs, when executed or loaded by an application, enable computing device 900 to implement features of embodiments discussed herein. Accordingly, such computer programs represent controllers of the computing device 900.

Embodiments are also directed to computer program products comprising computer code or instructions stored on any computer-readable medium or computer-readable storage medium. Such computer program products include hard disk drives, optical disk drives, memory device packages, portable memory sticks, memory cards, and other types of physical storage hardware.

### IV. Additional Examples and Advantages

As described, systems and devices embodying the techniques herein may be configured and enabled in various ways to perform their respective functions for optimization in query plans via a query optimizer advisor. In embodiments, one or more of the steps or operations of any flowchart and/or flow diagram described herein may not be performed. Moreover, steps or operations in addition to or in lieu of those in any flowchart and/or flow diagram described herein may be performed. Further, in examples, one or more operations of any flowchart and/or flow diagram described herein may be performed out of order, in an alternate sequence, or partially (or completely) concurrently with each other or with other operations.

As described herein, systems, devices, components, etc., of the embodiments that are configured to perform functions and/or operations are also contemplated as performing such functions and/or operations.

Prior solutions fail to address the limitations on resources that are present in real-world implementations of computing systems, much less doing so in the context of large-scale data processing systems and optimization of query plans. Thus, prior solutions also fail to adequately address performance regressions in the query plans that are generated. In contrast, the embodiments herein utilize an offline QO-Advisor pipeline that employs 1-edit distance rule configuration changes and scoped testing of rule configuration changes in jobs to identify performance regressions. This enables a greater understanding of computing system implementations for query plan optimizations but does so in a manner that utilizes fewer system resources (CPU cycles, memory footprint, system time required, etc.) and identifies performance regressions prior to implementing hints. These and other improvements described herein for optimization in query plans via a query optimizer advisor were previously not available for software-based platforms and networks, much less for the specific system implementations, organizations, and architectures in the embodiments described herein. Consequently, the QO-Advisor aspects described are a unique and resource-effective way to steer a query optimizer. Further, the QO-Advisor pipeline herein may run offline periodically (e.g., once a day) and thus may be deployed over different computational platform clusters for a given workload tier.

Embodiments contemplate multiple rule flips, e.g., by utilizing techniques from combinatorial contextual bandits or short-horizon episodic reinforcement learning. Embodiments contemplate the ability to optimistically accept proposed query plans and detect regressions from subsequent runtime metrics. Embodiments also contemplate utilizing testing/flighting as part of modeling such that which job to test/flight may be chosen based on what part of the space the model determines is better to explore where recurrent jobs as well as any jobs may be provided with rule hints. Such embodiments contemplate a tighter integration between the query optimizer and the recommendation modeler in an online learning setting, with assistance from an offline pipeline for exploring new configurations. Embodiments also contemplate improving the quality of query plans in relation to the quality of the estimated costs and cardinalities, where the QO-Advisor pipeline avoids large variances in estimations by learning how to directly steer the query optimizer towards better plans.

Contextual bandit formulation is discussed in further detail below. In contextual bandits, the learning algorithm repeatedly receives a context and action-set pair (x, {αi}), it chooses an action αi, and then receives reward r. To formulate query optimization as a contextual bandit, the context, the actions, and the rewards are each specified. A recommendation model consumes information available after the default compilation and optionally recommends an alternative compilation, as illustrated in FIG. 4 and described above. A fractional reduction in (optimizer) estimated cost may be used as the reward, as noted. Rewards with extreme dynamic ranges can cause problems for existing learning algorithms, and accordingly, aspects herein use clipping to mitigate the effects of outliers when training (but not when reporting results). The specification of the action set {ai} leverages the concepts of rule signature and job span introduced above, and the main statistical issue is to limit the number of actions per example in order to control the amount of data required for learning to converge. With B possible bits in the rule signature, there are naïvely 2B possible actions corresponding to each rule signature. As this is intractably large, aspects herein may only consider the rule signatures which differ in the job span. If there are S bits in the job span for a query, then there are 2S possible actions corresponding to possible settings of the job span bits. Some aspects limit the action space to single bit deviations from the default query plan (both to reduce data requirements for learning and for other reasons discussed above). Thus the number of possible actions is (1+S) corresponding to either changing nothing (1) or flipping a single bit in the job span (S). Empirically, S may be on average 10 but with a long tail distribution, so having actions scale linearly with S ensures tractability.

For the context, any information which is known after the initial default compilation can in principle be utilized. Representing the logical query by the job span itself is an effective approach over prior solutions. In other words, the complete set of bit positions in the job span provides valuable and concise information about which bits can be flipped to improve the result, especially when interacted to create second and third order co-occurrence indicators. Beyond these features, representing some properties of the input data streams (e.g., row count) also provides improvements. The validation component consumes information available after a single testing/flighting run of the query plan and decides whether to accept or reject the modified query plan. Because there are only two actions, and because the reward is known (relative change is 0), this may be treated as a supervised learning problem, and a model trained on a fixed dataset may be utilized.

The additional examples and embodiments described in this Section may be applicable to examples disclosed in any other Section or subsection of this disclosure.

Aspects and embodiments herein are provided for optimization in query plans via a query optimizer advisor. For instance, a system is described herein. The system includes a program memory that stores program code, and a processing system including one or more processors configured to receive the program code from the program memory and, in response to at least receiving the program code, to perform operations. The operations include to receive historical information as an input, the historical information including job execution metadata of a distributed data processing system, and to generate a set of one or more rule hint pairs based at least on the historical information that is received. The operations also include to provide the set to a query plan optimizer, and to optimize a query plan of an incoming query, via the query plan optimizer, through application of at least one of the rule hint pairs in the set that is based at least on a characteristic of the incoming query matching a portion of the at least one of the rule hint pairs.

In an embodiment of the system, each rule hint pair in the set of one or more rule hint pairs includes a job template identifier and a rule hint, and the characteristic of the incoming query matching the portion of the at least one of the rule hint pairs includes a portion of the incoming query matching the job template identifier.

In an embodiment of the system, the application of the at least one of the rule hint pairs in the set includes applying a respective rule hint of the at least one of the rule hint pairs that steers the query plan optimizer in optimization of the query plan at a compile time of the incoming query.

In an embodiment of the system, each of the respective rule hint of the at least one of the rule hint pairs modifies a single rule utilized by the query plan optimizer.

In an embodiment of the system, the job execution metadata of the distributed data processing system is for a specified time period.

In an embodiment of the system, to generate the set of one or more rule hint pairs includes to featurize the historical information to generate features, and to identify a rule hint based at least on a contextual bandit algorithm that takes as an input the features associated with the historical information.

In an embodiment of the system, the at least one operation includes a query optimizer advisor pipeline that includes at least one of: a first additional operation to recompile a past job associated with the job execution metadata based at least on respective rule hint of the one or more rule hint pairs; a second additional operation to identify errors during a recompilation that correspond to ones of the respective rule hint of the one or more rule hint pairs; a third additional operation to determine an estimated plan cost for each recompilation; a fourth additional operation to validate any recompilations having respective estimated plan costs, which satisfy a cost condition, via a linear regression model that identifies performance regressions; or a fifth additional operation to store the set in a data structure that is provided to the query plan optimizer.

A method is also provided herein. The method is performed by a processing system. The method includes receiving historical information as an input, the historical information including job execution metadata of a distributed data processing system, and generating a set of one or more rule hint pairs based at least on the historical information that is received. The method also includes providing the set to a query plan optimizer, and optimizing a query plan of an incoming query, via the query plan optimizer, through application of at least one of the rule hint pairs in the set that is based at least on a characteristic of the incoming query matching a portion of the at least one of the rule hint pairs.

In an embodiment of the method, each rule hint pair in the set of one or more rule hint pairs includes a job template identifier and a rule hint, and the characteristic of the incoming query matching the portion of the at least one of the rule hint pairs includes a portion of the incoming query matching the job template identifier.

In an embodiment of the method, the application of the at least one of the rule hint pairs in the set includes applying a respective rule hint of the at least one of the rule hint pairs that steers the query plan optimizer in optimization of the query plan at a compile time of the incoming query.

In an embodiment of the method: each of the respective rule hint of the at least one of the rule hint pairs modifies a single rule utilized by the query plan optimizer; or the job execution metadata of the distributed data processing system is for a specified time period.

In an embodiment of the method, generating the set of one or more rule hint pairs includes: featurizing the historical information to generate features, and identifying a rule hint based at least on a contextual bandit algorithm that takes as an input the features associated with the historical information.

In an embodiment of the method, the at least one operation includes a query optimizer advisor pipeline that includes at least one of: a first additional operation to recompile a past job associated with the job execution metadata based at least on respective rule hint of the one or more rule hint pairs; a second additional operation to identify errors during a recompilation that correspond to ones of the respective rule hint of the one or more rule hint pairs; a third additional operation to determine an estimated plan cost for each recompilation; a fourth additional operation to validate any recompilations having respective estimated plan costs, which satisfy a cost condition, via a linear regression model that identifies performance regressions; or a fifth additional operation to store the set in a data structure that is provided to the query plan optimizer.

In an embodiment of the method, at least a portion of the query optimizer advisor pipeline is executed offline and periodically.

A computer-readable storage medium having program instructions recorded thereon that are executable by a processing system to perform a method is also described. The method includes receiving historical information as an input, the historical information including job execution metadata of a distributed data processing system, and generating a set of one or more rule hint pairs based at least on the historical information that is received. The method also includes providing the set to a query plan optimizer, and optimizing a query plan of an incoming query, via the query plan optimizer, through application of at least one of the rule hint pairs in the set that is based at least on a characteristic of the incoming query matching a portion of the at least one of the rule hint pairs.

In an embodiment of the computer-readable storage medium, each rule hint pair in the set of one or more rule hint pairs includes a job template identifier and a rule hint, and the characteristic of the incoming query matching the portion of the at least one of the rule hint pairs includes a portion of the incoming query matching the job template identifier.

In an embodiment of the computer-readable storage medium, the application of the at least one of the rule hint pairs in the set includes applying a respective rule hint of the at least one of the rule hint pairs that steers the query plan optimizer in optimization of the query plan at a compile time of the incoming query.

In an embodiment of the computer-readable storage medium, each of the respective rule hint of the at least one of the rule hint pairs modifies a single rule utilized by the query plan optimizer.

In an embodiment of the computer-readable storage medium, generating the set of one or more rule hint pairs includes: featurizing the historical information to generate features, and identifying a rule hint based at least on a contextual bandit algorithm that takes as an input the features associated with the historical information.

In an embodiment of the computer-readable storage medium, the at least one operation includes a query optimizer advisor pipeline that includes at least one of: a first additional operation to recompile a past job associated with the job execution metadata based at least on respective rule hint of the one or more rule hint pairs; a second additional operation to identify errors during a recompilation that correspond to ones of the respective rule hint of the one or more rule hint pairs; a third additional operation to determine an estimated plan cost for each recompilation; a fourth additional operation to validate any recompilations having respective estimated plan costs, which satisfy a cost condition, via a linear regression model that identifies performance regressions; or a fifth additional operation to store the set in a data structure that is provided to the query plan optimizer.

### V. CONCLUSION

While various embodiments of the disclosed subject matter have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

What is claimed is:

1. A system comprising:
a program memory that stores program code; and
a processing system comprising one or more processors configured to receive the program code from the program memory and, in response to at least receiving the program code, to perform operations comprising to:
receive historical information as an input, the historical information comprising job execution metadata of a distributed data processing system;
generate a set of one or more rule hint pairs based at least on the historical information that is received;
provide the set to a query plan optimizer; and
optimize a query plan of an incoming query, via the query plan optimizer, through application of at least one of the rule hint pairs in the set that is based at least on a characteristic of the incoming query matching a portion of the at least one of the rule hint pairs.

2. The system of claim 1, wherein each rule hint pair in the set of one or more rule hint pairs comprises a job template identifier and a rule hint; and
wherein the characteristic of the incoming query matching the portion of the at least one of the rule hint pairs includes a portion of the incoming query matching the job template identifier.

3. The system of claim 2, wherein the application of the at least one of the rule hint pairs in the set comprises applying a respective rule hint of the at least one of the rule hint pairs that steers the query plan optimizer in optimization of the query plan at a compile time of the incoming query.

4. The system of claim 3, wherein each of the respective rule hint of the at least one of the rule hint pairs modifies a single rule utilized by the query plan optimizer.

5. The system of claim 2, wherein the job execution metadata of the distributed data processing system is for a specified time period.

6. The system of claim 2, wherein said generate the set of one or more rule hint pairs includes to:
featurize the historical information to generate features; and
identify a rule hint based at least on a contextual bandit algorithm that takes as an input the features associated with the historical information.

7. The system of claim 1, wherein the at least one operation comprises a query optimizer advisor pipeline that includes at least one of:
a first additional operation to recompile a past job associated with the job execution metadata based at least on respective rule hint of the one or more rule hint pairs;
a second additional operation to identify errors during a recompilation that correspond to ones of the respective rule hint of the one or more rule hint pairs;
a third additional operation to determine an estimated plan cost for each recompilation;
a fourth additional operation to validate any recompilations having respective estimated plan costs, which satisfy a cost condition, via a linear regression model that identifies performance regressions; or
a fifth additional operation to store the set in a data structure that is provided to the query plan optimizer.

8. A method performed by a processing system, the method comprising:
receiving historical information as an input, the historical information comprising job execution metadata of a distributed data processing system;
generating a set of one or more rule hint pairs based at least on the historical information that is received;
providing the set to a query plan optimizer; and
optimizing a query plan of an incoming query, via the query plan optimizer, through application of at least one of the rule hint pairs in the set that is based at least on a characteristic of the incoming query matching a portion of the at least one of the rule hint pairs.

9. The method of claim 8, wherein each rule hint pair in the set of one or more rule hint pairs comprises a job template identifier and a rule hint; and
wherein the characteristic of the incoming query matching the portion of the at least one of the rule hint pairs includes a portion of the incoming query matching the job template identifier.

10. The method of claim 9, wherein the application of the at least one of the rule hint pairs in the set comprises applying a respective rule hint of the at least one of the rule hint pairs that steers the query plan optimizer in optimization of the query plan at a compile time of the incoming query.

11. The method of claim 10, wherein each of the respective rule hint of the at least one of the rule hint pairs modifies a single rule utilized by the query plan optimizer; or
wherein the job execution metadata of the distributed data processing system is for a specified time period.

12. The method of claim 9, wherein said generating the set of one or more rule hint pairs includes:
featurizing the historical information to generate features; and
identifying a rule hint based at least on a contextual bandit algorithm that takes as an input the features associated with the historical information.

13. The method of claim 8, wherein the at least one operation comprises a query optimizer advisor pipeline that includes at least one of:
a first additional operation to recompile a past job associated with the job execution metadata based at least on respective rule hint of the one or more rule hint pairs;
a second additional operation to identify errors during a recompilation that correspond to ones of the respective rule hint of the one or more rule hint pairs;
a third additional operation to determine an estimated plan cost for each recompilation;
a fourth additional operation to validate any recompilations having respective estimated plan costs, which satisfy a cost condition, via a linear regression model that identifies performance regressions; or
a fifth additional operation to store the set in a data structure that is provided to the query plan optimizer.

14. The method of claim 13, wherein at least a portion of the query optimizer advisor pipeline is executed offline and periodically.

15. A computer-readable storage medium having program instructions recorded thereon that are executable by a processing system to perform a method, the method comprising:
receiving historical information as an input, the historical information comprising job execution metadata of a distributed data processing system;
generating a set of one or more rule hint pairs based at least on the historical information that is received;
providing the set to a query plan optimizer; and
optimizing a query plan of an incoming query, via the query plan optimizer, through application of at least one of the rule hint pairs in the set that is based at least on a characteristic of the incoming query matching a portion of the at least one of the rule hint pairs.

16. The computer-readable storage medium of claim 15, wherein each rule hint pair in the set of one or more rule hint pairs comprises a job template identifier and a rule hint; and
wherein the characteristic of the incoming query matching the portion of the at least one of the rule hint pairs includes a portion of the incoming query matching the job template identifier.

17. The computer-readable storage medium of claim 16, wherein the application of the at least one of the rule hint pairs in the set comprises applying a respective rule hint of the at least one of the rule hint pairs that steers the query plan optimizer in optimization of the query plan at a compile time of the incoming query.

18. The computer-readable storage medium of claim 17, wherein each of the respective rule hint of the at least one of the rule hint pairs modifies a single rule utilized by the query plan optimizer.

19. The computer-readable storage medium of claim 16, wherein said generating the set of one or more rule hint pairs includes:
featurizing the historical information to generate features; and
identifying a rule hint based at least on a contextual bandit algorithm that takes as an input the features associated with the historical information.

20. The computer-readable storage medium of claim 15, wherein the at least one operation comprises a query optimizer advisor pipeline that includes at least one of:
a first additional operation to recompile a past job associated with the job execution metadata based at least on respective rule hint of the one or more rule hint pairs;
a second additional operation to identify errors during a recompilation that correspond to ones of the respective rule hint of the one or more rule hint pairs;
a third additional operation to determine an estimated plan cost for each recompilation;
a fourth additional operation to validate any recompilations having respective estimated plan costs, which satisfy a cost condition, via a linear regression model that identifies performance regressions; or
a fifth additional operation to store the set in a data structure that is provided to the query plan optimizer.
